(19) United States
(12) Patent Application Publication
(10) Pub. No.: US 2025/0235962 A1
(43) Pub. Date: Jul. 24, 2025

(54) NANOPARTICLE-BASED FLUX WITH NONEVAPORABLE SOLVENT FOR TUNGSTEN INERT GAS (TIG) WELDING OF THICK PLATES

(71) Applicants: Sebastian BALOS, Novi Sad (RS); Ivan Zabunov, Backi Petrovac (RS); Miroslav Dramicanin, Novi Sad (RS); Petar Janjatovic, Novi Sad (RS); University of New Hampshire, Durham, NH (US)

(72) Inventors: Sebastian Balos, Novi Sad (RS); Ivan Zabunov, Novi Sad (RS); Miroslav Dramicanin, Novi Sad (RS); Petar Janjatovic, Novi Sad (RS); Marko Knezevic, Durham, NH (US)

(21) Appl. No.: 18/853,926

(22) PCT Filed: Apr. 7, 2023
(86) PCT No.: PCT/US23/17903

§ 371 Date: Oct. 3, 2024

Related U.S. Application Data
(60) Provisional application No. 63/362,625, filed on Apr. 7, 2022.

(51) Int. Cl. B23K 35/362; B23K 35/36

(52) U.S. Cl. CPC B23K 35/362; B23K 35/3607; B23K 35/3608

(57) ABSTRACT

The system and method for tungsten inert gas (TIG) welding of thick plates (e.g. 10 mm or more) using a flux comprising a mixture of nanoparticle-sized oxides in a volume of nonevaporable sodium silicate (Na₂xSiO₂+x or (Na₂O)x·SiO) solvent. The nanoparticle-sized oxides may be Titanium oxide and Silicon oxide. The solvent may be at least one of sodium metasilicate (Na₂SiO₃), sodium orthosilicate (Na₄SiO₄), or sodium pyrosilicate (Na₆Si₂O₇). Use of the flux provides for forming a weld having a cross-section having complete penetration to up to 14 mm using a current of about 300 A.

### FIELD OF THE DISCLOSURE

The present disclosure relates to welding and more particularly to a nanoparticle-based flux with nonevaporable solvent for use in tungsten inert gas (TIG) welding.

### BACKGROUND OF THE DISCLOSURE

Tungsten inert gas (TIG) welding process has a major drawback related to low productivity pertaining to a relatively low penetration achievable in a single pass, e.g. usually around 3 mm. For thicker sections/plates, preparation involving consumables along with multi pass welding is needed. In particular, a consumable material in the form of a wire and an increase in shielding gas consumption are necessary. These adaptations increase both welding time and costs. Moreover, being multi pass welding, there is an increased risk of creating defects in the weld. Therefore, an increase in penetration would be a significant breakthrough, which would greatly benefit industrial sectors.

To increase the depth of penetration, special fluxes were developed. These include a combination of oxides and/or halides in volatile and highly evaporable liquid such as alcohol (ethanol or methanol) or acetone. The fluxes are applied to the base metal just before welding. However, evaporable solvent shortens the shelf life of the flux. Even a small evaporated amount of the solvent that evaporates during storage causes a higher oxide/halide amount to be present in the flux. As a result, the flux effectiveness is reduced. Therefore, besides the increase in flux effectiveness, it is of great interest to increase the shelf life of flux.

Wherefore it is an object of the present disclosure to overcome the above-mentioned shortcomings and drawbacks associated with conventional fluxes.

### SUMMARY OF THE DISCLOSURE

It is recognized that conventional fluxes have low productivity pertaining to a relatively low penetration and a short shelf life. As described herein, a nanoparticle-based flux having a nonevaporable solvent for use in tungsten inert gas (TIG) welding is described. This flux provides for an extended shelf life and improved penetration.

One aspect of the present disclosure is a flux for tungsten inert gas (TIG) welding of thick plates (e.g., 10 mm and thicker). The flux also includes a plurality of nanoparticle-sized oxides mixed into a volume of a nonevaporable sodium silicate solvent.

Implementations may include one or more of the following features. The flux where the plurality of nanoparticle-sized oxides may include a mixture of titanium oxide and silicon oxide. A size of titanium oxide particles ranges from about 15 to about 25 nm. A size of silicon oxide particles ranges from about 30 to about 50 nm.

In some implementations, implementations may include one or more of the following features. The flux may include about 10-40% hydrophilic titanium oxide. The flux may include about 60-90% hydrophilic silicon oxide.

In certain implementations, implementations may include one or more of the following features. The nonevaporable sodium silicate solvent may include Na₂xSiO₂+x or (Na₂O)x·SiO. The nonevaporable sodium silicate solvent may include at least one of sodium metasilicate (Na₂SiO₃), sodium orthosilicate (Na₄SiO₄), or sodium pyrosilicate (Na₆Si₂O₇). The plurality of nanoparticle-sized oxides are mixed into the nonevaporable sodium silicate solvent in a range of about 5-7% weight.

Another aspect of the present disclosure is a flux for tungsten inert gas (TIG) welding of thick plates. The flux also includes a mixture of nanoparticle-sized titanium oxide and silicon oxide in a volume of a nonevaporable sodium silicate Na₂xSiO₂+x or (Na₂O)x·SiO solvent.

Implementations may include one or more of the following features. The flux where a size of titanium oxide particles ranges from about 15 to about 25 nm. A size of silicon oxide particles ranges from about 30 to about 50 nm. The nonevaporable sodium silicate solvent may include at least one of sodium metasilicate (Na₂SiO₃), sodium orthosilicate (Na₄SiO₄), or sodium pyrosilicate (Na₆Si₂O₇). The mixture of nanoparticle-sized oxides are mixed into the nonevaporable sodium silicate solvent in a range of about 5-7% weight. The flux may include about 10-40% hydrophilic titanium oxide. The flux may include about 60-90% hydrophilic silicon oxide.

Yet another aspect of the present disclosure is a method for tungsten inert gas (TIG) welding of thick plates applying a flux to a surface of plates, the flux may include: a mixture of nanoparticle-sized titanium oxide and silicon oxide in a volume of a nonevaporable sodium silicate Na₂xSiO₂+x or (Na₂O)x·SiO solvent; applying a current to the surface of the plates using an a-tig process; and forming a weld having a cross-section having complete penetration.

Implementations may include one or more of the following features. The method where the current is between 190 and 210 A and the plates have a thickness of 10 mm. The current is between 280 and 320 A and the plates have a thickness of up to 14 mm.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1A shows an adding and weighing step for one implementation of a nanoparticle-based flux with nonevaporable solvent for tungsten inert gas (TIG) welding according to the principles of the present disclosure.

FIG. 1B shows a mixing step for one implementation of a nanoparticle-based flux with nonevaporable solvent for tungsten inert gas (TIG) welding according to the principles of the present disclosure.

FIG. 1C shows an applying step for one implementation of a nanoparticle-based flux with nonevaporable solvent for tungsten inert gas (TIG) welding according to the principles of the present disclosure.

FIG. 1D shows a welding step for one implementation of a nanoparticle-based flux with nonevaporable solvent for tungsten inert gas (TIG) welding according to the principles of the present disclosure.

FIG. 2 shows a weld cross-section having a complete penetration for 10 mm thick 304L austenitic stainless steel plates after using an A-TIG process utilizing one implementation of the flux of the present disclosure at 200 A.

FIG. 3 shows a weld cross-section having a complete penetration for 14 mm thick 304L austenitic stainless steel plates after using an A-TIG process utilizing one implementation of the flux of the present disclosure at 300 A.

FIG. 4 is a flowchart of one implementation of a method of tungsten inert gas (TIG) welding with a nanoparticle-based flux with nonevaporable solvent according to the principles of the present disclosure.

### DETAILED DESCRIPTION OF THE DISCLOSURE

One implementation of a nanoparticle-based flux with nonevaporable solvent for tungsten inert gas (TIG) welding according to the present disclosure has several key features. One feature is the application of oxides having an average diameter of several tens of nanometers and being of different types. Another feature is the application of a solvent that will not evaporate readily at room temperature. Nano-particle based penetrating flux can have a higher penetration compared to micro-particle fluxes due to a higher number of vaporized molecules and dissociated atoms in nano particles compared to micro particles. This causes a quicker reversal of Marangoni convection in the melt pool as well as more pronounced arc constriction. In certain implementations, the resulting penetration is up to 14 mm of austenitic stainless steel with 300 A direct current. In certain cases, the form of the flux is liquid that can be applied by a brush or sprayed prior to welding. Yet another feature of the present disclosure is the solvent, which is a readily non-evaporable solvent at room temperature. In certain implementations, the solvent used prevents changes in the composition of the flux, that is, in the concentration of active substance(s), the oxides, over time. This is of great importance as it increases the shelf life of the product, due to increased stability of the flux.

Commercially available products use micrometer sized oxide particles and evaporable solvent. In contrast, the nanoparticle-based flux with nonevaporable solvent for tungsten inert gas (TIG) welding according to the present disclosure, uses a combination of nanometer sized oxides to provide a higher penetration compared to micro-particle fluxes due to a higher number of vaporized molecules and dissociated atoms in nano particles compared to micro particles. This causes a quicker reversal of Marangoni convection in the melt pool as well as more pronounced arc constriction. Thus, in certain implementations of the present disclosure, the resulting penetration is to about 14 mm of austenitic stainless steel with 300 A direct current. Also, the nonevaporable solvent provides a longer shelf-life, that is, a prolonged effectiveness of the product.

Mechanical properties of welds obtained by A-TIG are generally lower than those of base material. In experiments, the strength of the weld metal was up to 95% of the base metal. One reason for this may be the existence of crystallized and segregated microstructure. In some cases, this limitation related to any A-TIG process that does not use consumable material can be overcome, while maintaining A-TIG advantages. If the limitations are relaxed, the present disclosure is applicable to any TIG process.

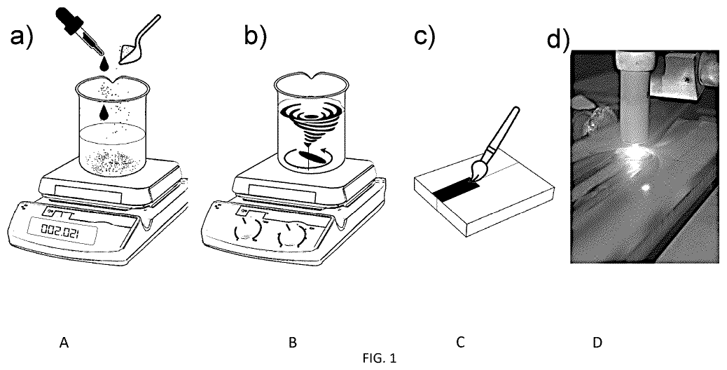

Referring to FIG. 1A, an adding and weighing step for one implementation of components in a nanoparticle-based flux with nonevaporable solvent for tungsten inert gas (TIG) welding according to the principles of the present disclosure is shown. More specifically, in certain implementations a combination of nanoparticles is used instead of micron-size particles and that results in a more effective flux. The nanoparticles react more readily than conventional micron-size particles usually used in A-TIG fluxes.

One implementation of the flux of the present disclosure comprises about 10-40% hydrophilic Titanium Oxide (TiO₂ 15-25 nm—nanometer); and about 60-90% hydrophilic Silicon Oxide (SiO₂ 30-50 nm—nanometer); at about 5-7% by weight of the oxide nano particles in the solvent.

Referring to FIG. 1B, a mixing step for one implementation of components in a nanoparticle-based flux with nonevaporable solvent for tungsten inert gas (TIG) welding according to the principles of the present disclosure is shown. More specifically, in certain implementations the solvent is sodium silicate Na₂xSiO₂+x or (Na₂O)x·SiO₂, of one of the following types: sodium metasilicate (Na₂SiO₃), sodium orthosilicate (Na₄SiO₄), or sodium pyrosilicate (Na₆Si₂O₇).

Referring to FIG. 1C, an applying step for one implementation of components in a nanoparticle-based flux with nonevaporable solvent for tungsten inert gas (TIG) welding according to the principles of the present disclosure is shown. More specifically, in certain implementations nano particles and solvent are mixed together and applied by a brush or sprayed over a joint area. In some cases, the flux is applied on the side over which the TIG electrode will pass.

Referring to FIG. 1D, a welding step for one implementation of components in a nanoparticle-based flux with nonevaporable solvent for tungsten inert gas (TIG) welding according to the principles of the present disclosure is shown. More specifically, in certain cases TIG welding is done without consumables, with a ISO WT20 (AWS EWTh-2) red marked electrode (with ˜2% ThO₂) electrode, sharpened to about 60° using an argon shielding gas with about a 10 L/min flow. In some cases, a welding speed of between 40 and 60 mm/min and a welding voltage of between 11 and 13 V is used.

In one implementation of the present disclosure, by applying different direct currents, different penetrations in austenitic stainless steel can be achieved. In some cases, on the root side, a flat ceramic backing plate is used to prevent excessive penetration. The following results were obtained on AISI 304L base metal.

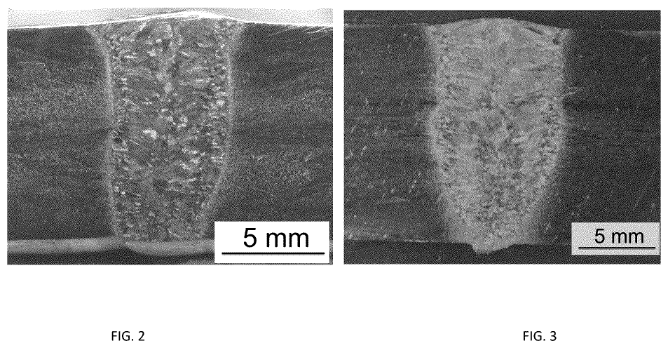

Referring to FIG. 2, a weld cross-section having a complete penetration for about a 10 mm thick 304L austenitic stainless steel plates after using an A-TIG process utilizing one implementation of the flux of the present disclosure at 200 A is shown. More specifically, 10 mm is possible with a current between 190 and 210 A.

Referring to FIG. 3, a weld cross-section having a complete penetration for about a 14 mm thick 304L austenitic stainless steel plates after using an A-TIG process utilizing one implementation of the flux of the present disclosure at 300 A is shown. More specifically, up to 14 mm is possible with a current between 280 and 320 A.

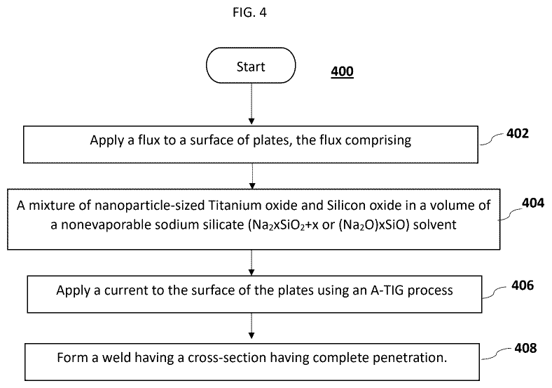

Referring to FIG. 4, a flowchart of one implementation of a method of welding of thick plates (e.g. 10 mm or higher) using a nanoparticle-based flux 400 with a nonevaporable solvent for tungsten inert gas (TIG) welding according to the principles of the present disclosure is shown. More specifically, a flux is applied to a surface of plates 402, the flux comprising a mixture of nanoparticle-sized Titanium oxide and Silicon oxide in a volume of a nonevaporable sodium silicate (Na₂xSiO₂+x or (Na₂O)xSiO) solvent 404. A current is applied to the surface of the plates using an A-TIG process 406. A weld is then formed having a cross-section having complete penetration 408.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the invention. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−2% of the stated value (or range of values). Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various implementations of the disclosure are examples and the disclosure is not limited to the exact details shown or described.

While various implementations of the present invention have been described in detail, it is apparent that various modifications and alterations of those implementations will occur to and be readily apparent to those skilled in the art. However, it is to be expressly understood that such modifications and alterations are within the scope and spirit of the present invention, as set forth in the appended claims. Further, the invention(s) described herein is capable of other implementations and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the implementations of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. A flux for tungsten inert gas (TIG) welding of plates, comprising:
a plurality of nanoparticle-sized oxides mixed into a volume of a nonevaporable sodium silicate solvent.

2. The flux according to claim 1, wherein the plurality of nanoparticle-sized oxides comprises a mixture of Titanium oxide and Silicon oxide.

3. The flux according to claim 2, wherein a size of Titanium oxide particles ranges from about 15 to about 25 nm.

4. The flux according to claim 2, wherein a size of Silicon oxide particles ranges from about 30 to about 50 nm.

5. The flux according to claim 1, wherein the nonevaporable sodium silicate solvent comprises Na₂xSiO₂+x or (Na₂O)x·SiO.

6. The flux according to claim 5, wherein the nonevaporable sodium silicate solvent comprises at least one of sodium metasilicate (Na₂SiO₃), sodium orthosilicate (Na₄SiO₄), or sodium pyrosilicate (Na₆Si₂O₇).

7. The flux according to claim 1, wherein the plurality of nanoparticle-sized oxides are mixed into the nonevaporable sodium silicate solvent in a range of about 5-7% weight.

8. The flux according to claim 2, wherein the flux comprises about 10-40% hydrophilic Titanium oxide.

9. The flux according to claim 2, wherein the flux comprises about 60-90% hydrophilic Silicon oxide.

10. A flux for tungsten inert gas (TIG) welding of plates, comprising:
a mixture of nanoparticle-sized Titanium oxide and Silicon oxide in a volume of a nonevaporable sodium silicate (Na₂xSiO₂+x or (Na₂O)x·SiO) solvent.

11. The flux according to claim 10, wherein a size of Titanium oxide particles ranges from about 15 to about 25 nm.

12. The flux according to claim 10, wherein a size of Silicon oxide particles ranges from about 30 to about 50 nm.

13. The flux according to claim 10, wherein the nonevaporable sodium silicate solvent comprises at least one of sodium metasilicate (Na₂SiO₃), sodium orthosilicate (Na₄SiO₄), or sodium pyrosilicate (Na₆Si₂O₇).

14. The flux according to claim 10, wherein the mixture of nanoparticle-sized oxides are mixed into the nonevaporable sodium silicate solvent in a range of about 5-7% weight.

15. The flux according to claim 10, wherein the flux comprises about 10-40% hydrophilic Titanium oxide.

16. The flux according to claim 10, wherein the flux comprises about 60-90% hydrophilic Silicon oxide.

17. A method for tungsten inert gas (TIG) welding of plates, comprising:
applying a flux to a surface of plates, the flux comprising:
a mixture of nanoparticle-sized Titanium oxide and Silicon oxide in a volume of a nonevaporable sodium silicate (Na₂xSiO₂+x or (Na₂O)x·SiO) solvent;
applying a current to the surface of the plates using an A-TIG process; and
forming a weld having a cross-section having complete penetration.

18. The method according to claim 17, wherein the current is between 190 and 210 A and the plates have a thickness of 10 mm.

19. The method according to claim 17, wherein the current is between 280 and 320 A and the plates have a thickness of up to 14 mm.

20. The method of claim 17, wherein the mixture of nanoparticle-sized oxides are mixed into the nonevaporable sodium silicate solvent in a range of about 5-7% weight, the flux comprises about 10-40% hydrophilic Titanium oxide, and the flux comprises about 60-90% hydrophilic Silicon oxide.
